(19) United States
(12) Patent Application Publication
(10) Pub. No.: US 2010/0251085 A1
(43) Pub. Date: Sep. 30, 2010

(54) CONTENT AND SUBFOLDER NAVIGATION CONTROL

(75) Inventors: David B. Zearing, Sammamish, WA (US); Seung-Hae Park, Renton, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/411,045

(22) Filed: Mar. 25, 2009

(51) Int. Cl. G06F 3/048; G06F 17/00

(52) U.S. Cl. 715/205; 715/854; 715/810

(57) ABSTRACT

Techniques for navigating content and one or more subfolders within a folder are described. In an implementation, an instance of content is situated in a folder. The folder also includes one or more subfolders that may each have one or more instances of content situated within them. When the instance of content is accessed, an iterator control may be provided that is scrollable to present one or more representations (e.g., icons) of content that is situated in the folder and one or more representations of subfolders that are situated in the folder. One or more of the representations of subfolders are selectable to navigate to a subfolder page.

### BACKGROUND

There is a tremendous amount of content available for consumption in today's networked environments. Many current techniques for accessing and navigating through content, however, can be counter-intuitive and may reduce a user's enjoyment of content. Particularly in web-based content scenarios, a lack of logical organization of content may overwhelm a user and may cause a particular instance of content to lose its pertinent context.

### SUMMARY

Techniques for navigating content and subfolders are described. In an implementation, a scrollable iterator control is presented that includes one or more representations of content that is situated within a folder. One or more of the representations of content are selectable to output an instance of content. A representation of a subfolder situated within the folder is also output within the scrollable iterator control. The representation of the subfolder is selectable to navigate within the subfolder.

In an implementation, an instance of content is retrieved from a folder maintained by a web resource. Information about one or more subfolders situated in the folder is also retrieved from the folder and the instance of content is output along with a folder iterator control adjacent to the instance of content. The folder iterator control is scrollable to present a plurality of icons associated with other instances of content situated in the folder and the one or more subfolders. One of more of the plurality of icons is selectable to navigate to a subfolder page associated with one of the one or more subfolders.

In an implementation, one or more computer-readable media include instructions that are executable by a device to receive a selection of a subfolder icon within a first iterator control. The first iterator control is scrollable to present one or more representations of content that is situated within a folder and one or more representations of subfolders that are situated within the folder. The instructions are further executable to navigate to a subfolder page associated with the subfolder icon. The subfolder page includes a second iterator control that is scrollable to present one or more representations of content that is situated within the subfolder.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform techniques for navigating through content and one or more subfolders.

FIG. 2 is an illustration of an example user interface for outputting content and an iterator control for navigating content and one or more subfolders.

FIG. 3 is an illustration of an example user interface for outputting content and an iterator control associated with a subfolder.

FIG. 4 is an illustration of an example iterator control configured to dynamically retrieve icons associated with content and subfolders.

FIG. 5 is a flow diagram depicting a procedure in an example implementation in which an iterator control is output for navigation of content and subfolders.

FIG. 6 is a flow diagram depicting a procedure in an example implementation in which icons within an iterator control are dynamically retrieved.

### DETAILED DESCRIPTION

Overview

Traditional techniques for accessing and navigating through content may be confusing and may overwhelm a user with the sheer amount of content available. For example, a user can send a link to a friend that allows the friend to access a collection of content. Content may include text documents, images, videos, audio files, and so on. When the friend selects the link and navigates to the collection of content (e.g., stored on a network drive, at a content sharing site, and so on), the friend may be presented with a large number of instances of content that may appear to be unrelated to each other and unorganized. Thus, navigation through the large number of instances of content may be cumbersome and reduce the friend's ability to enjoy of the content.

Techniques for navigating through content and one or more subfolders are described. In an implementation, an instance of content (e.g., a photograph) is situated in a folder. The folder also includes one or more subfolders that may each have one or more instances of content situated within them. When the instance of content is accessed, an iterator control may be provided that is scrollable to present a plurality of representations of the content (e.g., icons) that is situated in the folder and one or more representations of the subfolders that are situated in the folder.

For example, a link (e.g., a hyperlink, a uniform resource locator (URL), and so on) may be received that is associated with a folder that includes content and one or more subfolders. When the link is selected (e.g., via a web browser), navigation to a folder may be performed. For example, a folder page for the folder may be presented. The folder page, such as a web page, displays one or more instances of content that is situated in the folder. The folder page also displays an iterator control. The iterator control includes one or more content icons that, if selected, cause one or more of the instances of content from the folder to be presented. For example, a content icon may include a thumbnail of a photograph. If the icon is selected, a full size version of the photograph may be presented. A plurality of the icons may be navigated through via scrolling controls associated with the iterator control.

The iterator control also includes one or more subfolder icons that represent one or more subfolders situated within the folder. If a subfolder icon is selected, navigation within one or more of the subfolders may be performed. For example, navigation to a subfolder page for the subfolder may occur. The subfolder page includes an iterator control that is scrollable to present one or more content icons and/or subfolder icons that represent content and/or subfolders situated within the subfolder.

Consider an example scenario where a user goes on vacation to Europe and takes pictures in several different countries. The user creates a folder called “Europe”, and includes several subfolders within the folder that correspond to several countries within Europe. The user then populates the folder and subfolders with the pictures and stores the folder and subfolders on a network-accessible resource.

The user then sends an email to a friend that includes a link to the network location of the folder. When the friend navigates to the network location of the folder (e.g., via a selection of the link), the friend is presented with a folder page for the folder. The folder page displays one or more pictures stored in the folder and an iterator control for the folder. The iterator control includes picture icons for pictures stored in the folder as well as subfolder icons for the subfolders (e.g., subfolders for “Germany”, “Austria”, “Italy”, and so on). If the friend selects one of the picture icons, a picture associated with the picture icon is displayed. If the friend selects one of the subfolder icons, a subfolder page is displayed. The subfolder page includes one or more pictures that are situated in the subfolder.

The subfolder page also includes its own iterator control that is scrollable to scroll through picture icons that represent pictures situated in the subfolder. The subfolder page's iterator control may also include subfolder icons for one or more subfolders situated within the subfolder. For example, the “Europe” folder includes an “Italy” subfolder, which in turn includes a “Rome” subfolder.

In the following discussion, an example environment is first described that is operable to perform techniques that relate to navigating content and one or more subfolders within a folder. Next, example user interfaces are described that may implement one or more techniques discussed herein. Finally, example procedures are described that may be employed in the example environment, as well as in other environments. Although content and subfolder navigation is described in a network environment in the following discussion, it should be readily apparent that subfolder navigation techniques may be employed in a wide variety of environments without departing from the spirit and scope thereof.

Example Environment

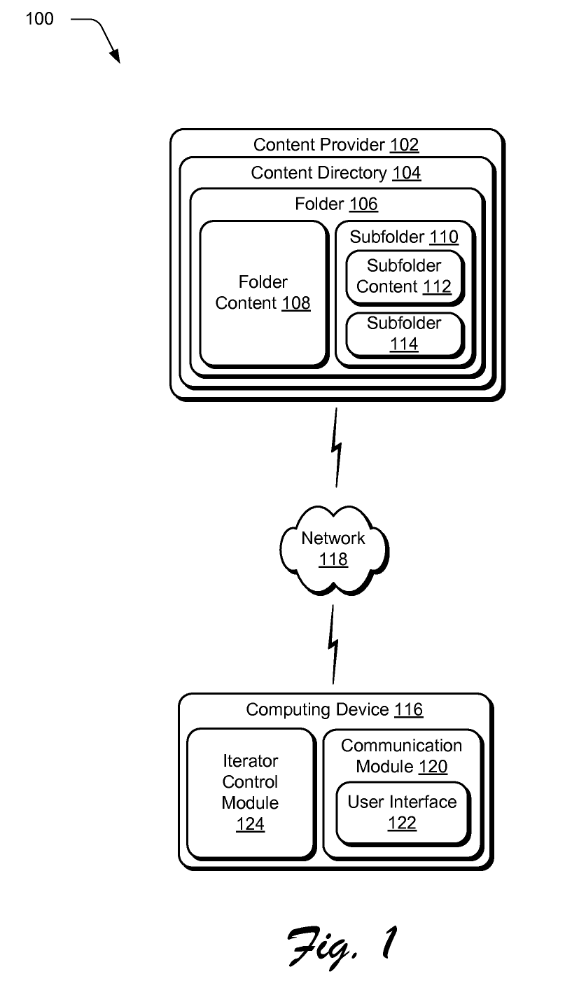

FIG. 1 is an illustration of an environment 100 in an example implementation that is operable to employ techniques for navigating content and subfolders. The illustrated environment 100 includes a content provider 102 and a content directory 104. The content provider 102 may include any suitable resource that may store and/or host content, such as a network drive, a web-based resource, a file sharing site, and so on. The content provider 102 may be configured in a variety of ways to receive, store, and/or host content. The content provider 102 may also be configured to provide content in response to a request for content. For example, the content provider 102 may be associated with one or more URLs and may be accessed via the URLs. Although the content provider 102 is illustrated as including the single content directory 104, it is to be appreciated that the content provider 102 may include and/or manage any suitable number of content directories.

In some implementations, content may be stored, organized, and/or managed by the content provider 102 using a variety of folders and subfolders. In this example implementation, the content provider 102 includes a folder 106, which in turn includes folder content 108 and a subfolder 110. The folder 106 and its contents (e.g., folder content 108, subfolder 110, and so on) may be stored in a physical memory maintained by the content provider 102, and/or at a remote resource that is accessible to the content provider 102. The subfolder 110 includes subfolder content 112 and a subfolder 114. The folder content 108 and/or the subfolder content 112 may include any suitable form of content.

The environment 100 is illustrated as also including a computing device 116 which may be configured in a variety of ways to access the content provider 102. The computing device 116 may include any suitable device, such as a desktop computer, a laptop computer, a personal digital assistant, a smart phone, and so. In some example implementations, the computing device 116 is configured to access the content provider 102 via a network 118. The network 118 may include any suitable network, such as the Internet, a wide area network (WAN), a local area network (LAN), a wireless network, a public telephone network, an intranet, and so on.

The computing device 116 is illustrated as including a communication module 120 that is representative of functionality of the computing device 116 to retrieve content from the content provide 102 and output the content. For example, the communication module 120 may include network functionality that enables the computing device 116 to communicate via one or more wired and/or wireless networks, such as the network 118.

The communication module 120 is illustrated as including a user interface 122 which is configured to enable a user to interact with the communication functionality and other functionality (e.g., one or more applications) provided by communication module 120. For example, the user interface 122 may be output on a display device via which a user may interact, such as a touchscreen, cursor control device, and so on. The user interface 122 may also be configured to output content, such as content provided by the content provider 102. For example, the user interface 122 may be configured to display content on a display screen of the computing device 116. Additionally, the computing device 116 may support a variety of different output techniques, such as audio output, tactile output, and so on.

The computing device 116 also includes an iterator control module 124 that is operable to generate and/or manage iterator controls for navigating content and subfolders. The iterator control module 124 may also be operable to generate and/or manage iterator controls that are displayed by the user interface 122.

In some example implementations, the content provider 102 and one or more of its components (e.g., the content directory 104, the folder 106, and so on) may be accessed via one or more URLs. For example, the URL “http://contentprovider102.net” may be used to access the content provider 102, and the URL “http://contentprovider102.net/contentdirectory104” may be used to access the content directory 104. Also, particular instances of content situated in folder 106, subfolder 110, and/or subfolder 114 may be accessible via a URL that is specific to an instance of content.

Generally, any of the functions described herein may be implemented using software, firmware, hardware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code may be stored in one or more computer readable memory devices, such as one or more computer readable storage media. The features of content and subfolder navigation techniques described below are platform-independent, meaning that the techniques may be implemented on a variety of commercial computing platforms having a variety of processors.

Example User Interfaces

The following discussion describes user interfaces that may implement one or more techniques discussed herein. The user interfaces may be implemented on any suitable computing device, such as the computing device 116 of environment 100. The arrangement of visual elements within the illustrated user interfaces is for purposes of example only, and it is to be appreciated that any suitable arrangement of visual elements may be utilized without departing from the spirit and scope thereof.

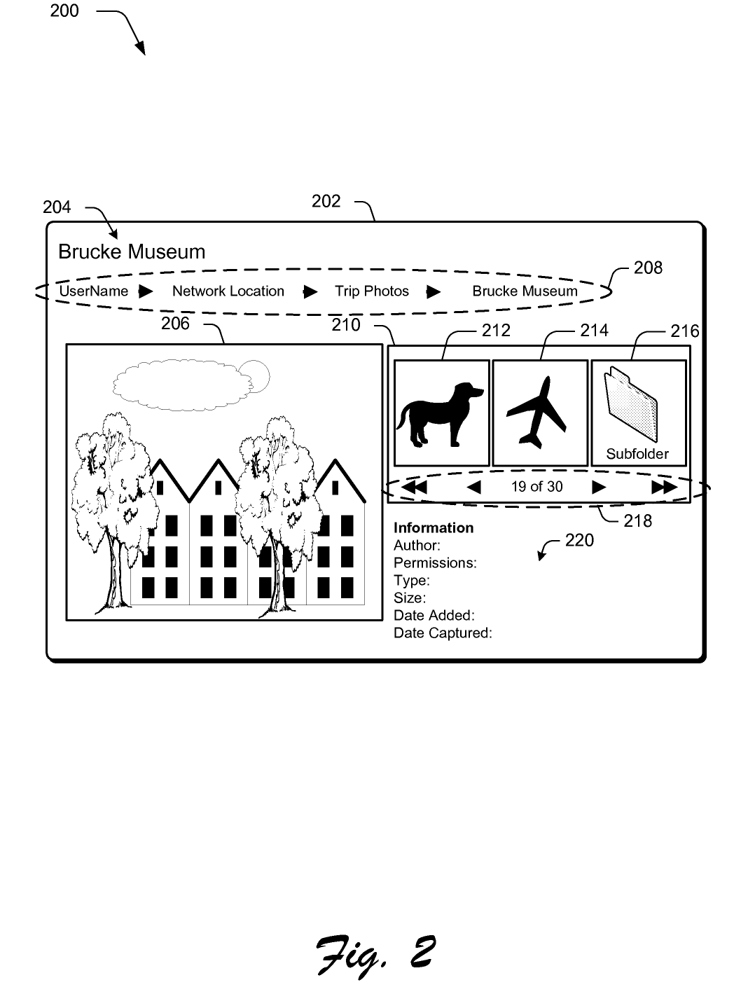

FIG. 2 illustrates at 200 a user interface 202 that may be implemented to display content and to access one or more subfolders. The user interface 202 includes a title 204 for an instance of content 206. In this example, the instance of content 206 is a photograph of the Brucke Museum in Berlin. The user interface 202 also includes a file path 208 that indicates a hierarchy associated with the instance content 206. The file path 208 indicates that the photograph is situated in a “trip photos” folder which is hosted at a particular network location associated with a particular user name. In some example implementations, one or more nodes on the file path 208 (e.g., the “Network Location” node) may be selectable to navigate to a location associated with the node.

The user interface 202 also includes an iterator control 210 that includes one or more representations of content (e.g., icons) that are selectable to access one or more instances of content, respectively. In this example, the iterator control 210 includes content icons 212, 214. Each of the content icons 212, 214 may be selected to access content that is represented by the content icons 212, 214.

The iterator control 210 also includes a subfolder icon 216 that is selectable to access the contents of a subfolder represented by the subfolder icon 216. In some example implementations, selection of the subfolder icon 216 causes navigation to a subfolder and/or navigation to a subfolder page, such as a web page, associated with the subfolder. In some implementations, the subfolder icon 216 may include one or more representations of content that is situated in the associated subfolder. For example, one or more thumbnails of pictures, video stills, text documents, or any other suitable content, may be displayed as part of the subfolder icon 216.

Iterator control 210 also includes navigation controls 218. When selected, the navigation controls 218 cause the iterator control to scroll through icons that represent content and/or subfolders situated in the “Trip Photos” folder. The navigation controls 218 include double-arrow controls that, if selected, may scroll quickly and/or instantly through the icons, and single arrow controls that, if selected, may scroll through the icons one at a time.

The user interface 202 also includes an information region 220 that may display information about a particular instance of content (e.g., the instance of content 206) and/or information about a particular folder or subfolder.

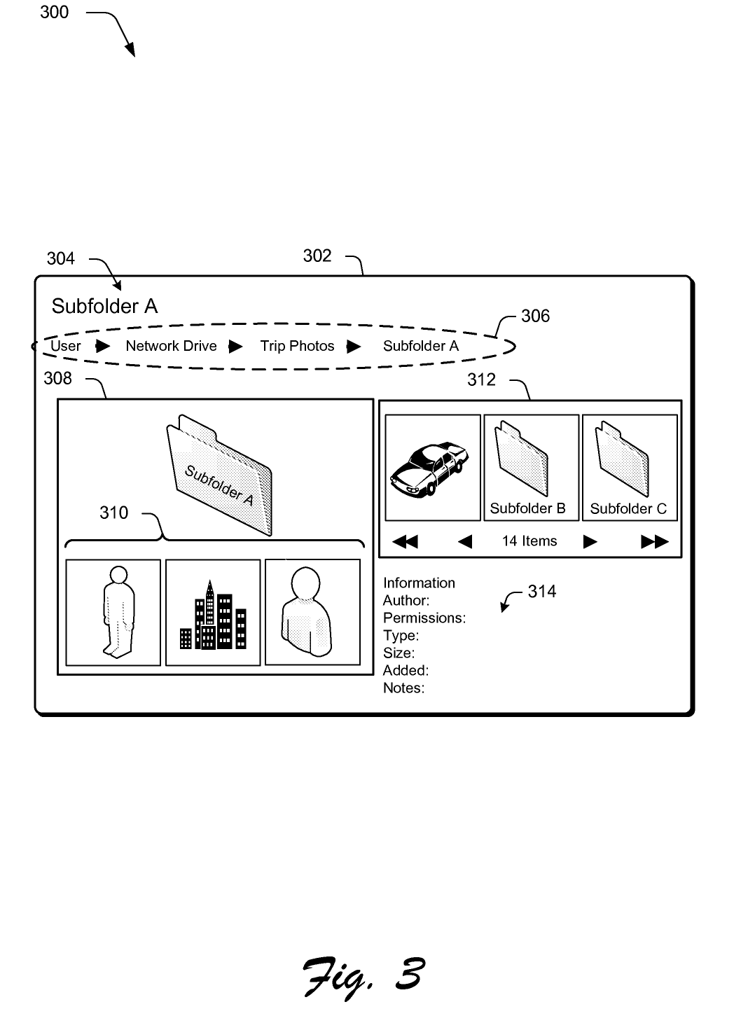

FIG. 3 illustrates at 300 a user interface 302 that is associated with a particular subfolder, e.g., the subfolder 110 illustrated in environment 100. In some implementations, the user interface 302 may be displayed in response to a selection of the subfolder icon 216 in the user interface 202. The user interface 302 may also be associated with a subfolder page (e.g., a web page) associated with the particular subfolder.

The user interface 302 includes a title 304 that, in this example, indicates a title for the subfolder, e.g., “Subfolder A”. The user interface 302 also includes a file path 306 that indicates a particular hierarchy associated with the subfolder. In this example, the file path 306 indicates that the Subfolder A is a subfolder situated within the Trip Photos folder.

A subfolder window 308 is also included as part of the user interface 302. The subfolder window 308 may display information about the subfolder and may include one or more icons that represent content and/or other subfolders situated within the subfolder. In this example, the subfolder window 308 includes content icons 310 that, if selected, cause one or more instances of content associated with one of the content icons 310 to be presented.

The user interface 302 also includes an iterator control 312 that is configured to display icons (e.g., content icons and/or subfolder icons) that are associated with content and/or subfolders situated within the Subfolder A. One or more of the icons is selectable to cause a particular instance of content to be presented or to navigate to a particular folder or subfolder associated with a selected icon. The iterator control 312 includes navigation controls in its lower portion that are selectable to scroll through the icons associated with the Subfolder A.

An information region 314 is also included as part of the user interface 302 and may display information about a particular subfolder and/or instance of content. For example, the information region 314 may display information about the Subfolder A.

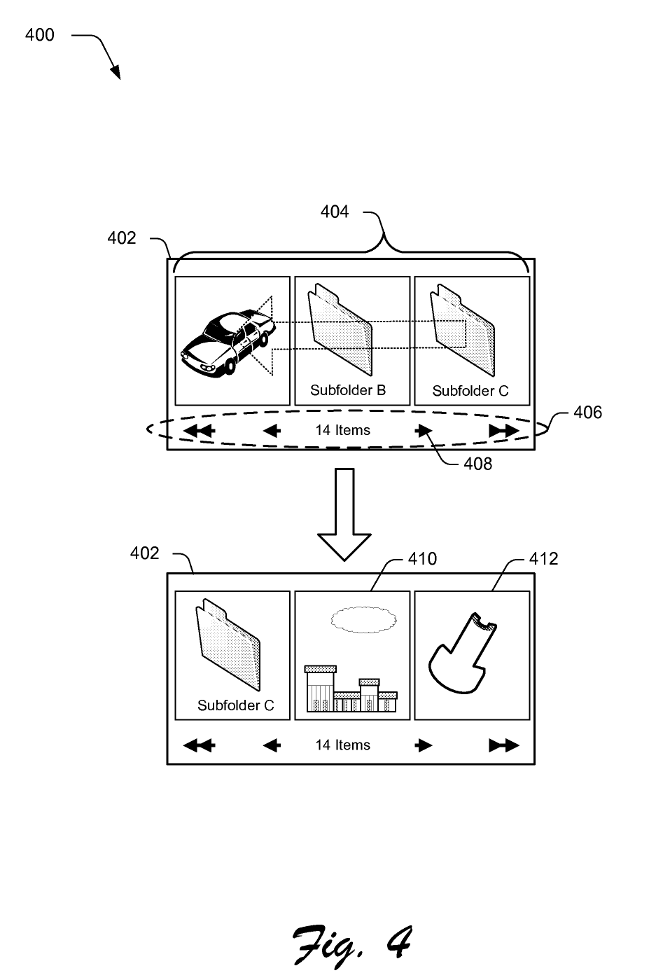

FIG. 4 illustrates at 400 in iterator control 402 that is operable to perform dynamic retrieval of icons. In this example, the iterator control 402 includes icons 404. The iterator control 402 also includes navigation controls 406 that, if selected, cause the iterator control 402 to scroll through the icons (e.g., icons 404) associated with the iterator control 402.

In this example, a user may select the arrow 408 to cause the iterator control 402 to scroll and cause the icons 404 to move towards the left side of the iterator control 402 and new icons to appear from the right side of the iterator control 402. This correlation between control direction and scroll direction is utilized or purposes of example only and any suitable correlation may be implemented. For example, in an alternate implementation, a selection of the arrow 408 may cause icons 404 to move to the right of the iterator control 402 and cause new icons to appear from the left side of the iterator control 402.

In this example implementation, the iterator control 402 is scrolled to the right, thus causing the icons 404 to move to the left of the iterator control 402 and causing the icons 410, 412 to enter the iterator control 402 from the right and be displayed in the iterator control 402. The scrolling of icons in the iterator control 402 may be dynamic in that as icons are scrolled, information about new icons (e.g., a thumbnail image, a folder name, an icon itself, and so on) that enter the iterator control 402 is dynamically retrieved. For example, the information may be dynamically retrieved from a remote resource, such as the content provider 102 of environment 100. This may allow the iterator control 402 to maintain information about a particular subset of icons in a particular folder without requiring the iterator control 402 to maintain information about all of the icons in the folder. This may be particularly useful in scenarios involving folders that include a large collection of content, thus allowing the iterator control 402 to conserve memory and/or processing resources.

Example Procedures

The following discussion describes content and subfolder techniques that may be implemented utilizing the previously described systems, devices, and user interfaces. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interfaces of FIGS. 2-4.

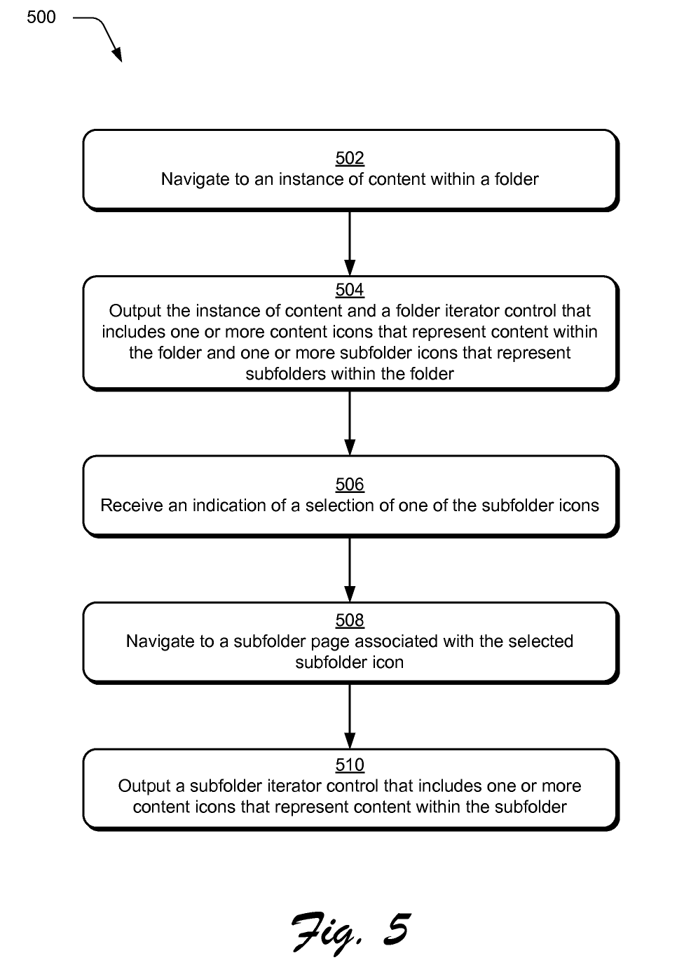

FIG. 5 depicts a procedure 500 in an example implementation in which an iterator control is output for navigation of content and subfolders. An instance of content within a folder is navigated to (block 502). For example, a URL associated with the instance of content may be utilized to retrieve the instance of content, e.g., via a web browser. The instance of content is output along with a folder iterator control that includes one or more content icons representing content within the folder and one or more subfolder icons representing subfolders within the folder (block 504). For example, a web page may display the instance of content and the iterator control adjacent to the instance of content.

An indication is received of a selection of one of these subfolder icons (block 506). For example, a user may select a subfolder icon using any suitable input method. Navigation is performed to a subfolder page associated with the selected subfolder icon (block 508). For example, the subfolder page may include a web page that is associated with a subfolder. While procedure 500 is discussed with reference to a subfolder page, this is for purpose of example only, and other example implementations may navigate directly to a subfolder and/or subfolder content. A subfolder iterator control is output that includes one or more content icons that represent content within the subfolder (block 510). The subfolder iterator control may be output as part of the subfolder page or adjacent to the subfolder page. In some implementations, the subfolder iterator control may include selectable subfolder icons for other subfolders.

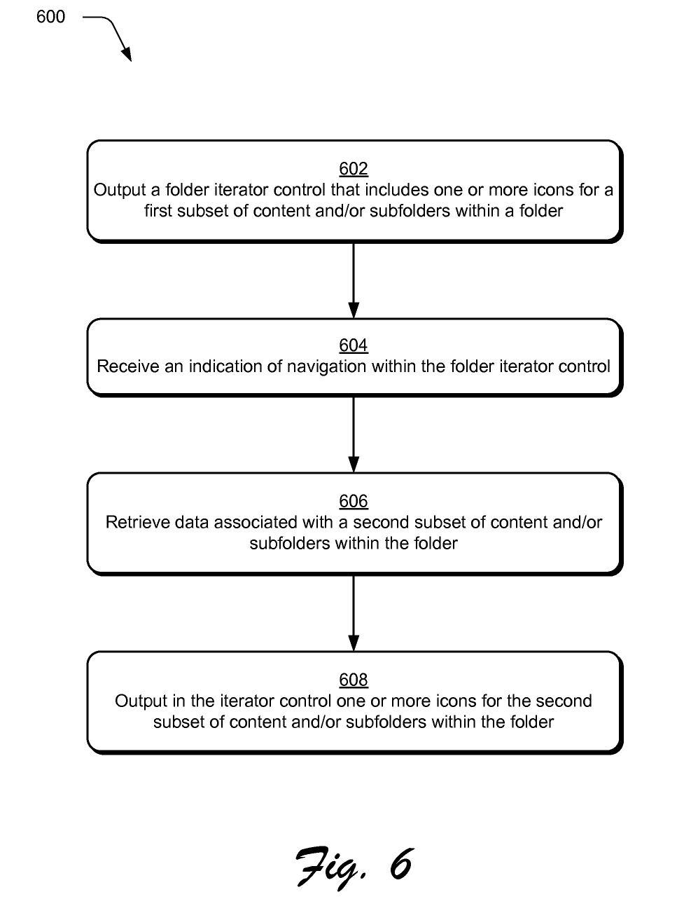

FIG. 6 depicts a procedure 600 in an example implementation in which icons within an iterator control are dynamically retrieved. A folder iterator control is output that includes one or more icons for a first subset of content and/or subfolders within a folder (block 602). An indication is received of navigation within the folder iterator control (block 604). For example, one or more navigation controls of the folder iterator control may be selected to scroll within the folder iterator control.

Data associated with a second subset of content and/or subfolders within the folder is retrieved (block 606). In some implementations, the data may include thumbnail images of the content and/or subfolders and may be dynamically retrieved responsive to receiving the indication of navigation within the folder iterator control. One or more icons for the second subset of content and/or subfolders within the folder are output in the iterator control (block 608).

Conclusion

Although embodiments have been described in language specific to structural features and/or methodological acts, it is to be understood that the invention defined in the appended claims is not necessarily limited to the specific features or acts described. Rather, the specific features and acts are disclosed as example forms of implementing the claimed embodiments.

What is claimed is:

1. A method comprising:
outputting a scrollable iterator control that includes one or more representations of content that is situated within a folder, the one or more representations of content being selectable to output an instance of content; and
outputting, within the scrollable iterator control, a representation of a subfolder situated within the folder, the representation of the subfolder being selectable to navigate within the subfolder.

2. A method as described in claim 1, wherein the scrollable iterator control is output as part of a web page retrieved from a network resource, the web page further including an instance of content retrieved from the folder.

3. A method as described in claim 1, wherein the scrollable iterator control is output responsive to navigation to an instance of content situated within the folder.

4. A method as described in claim 3, wherein the navigation to the instance of content is via a uniform resource locator (URL) associated with the instance of content.

5. A method as described in claim 1, further comprising outputting the scrollable iterator control via a web browser.

6. A method as described in claim 1, wherein the scrollable iterator control is configured to dynamically retrieve one or more other representations of content that is situated within the folder from a remote resource and responsive to a navigation within the scrollable iterator control.

7. A method as described in claim 1, wherein the subfolder is associated with a subfolder page comprising a subfolder iterator control, the subfolder iterator control including one or more representations of content that is situated within the subfolder.

8. A method as described in claim 1, further comprising:
retrieving, responsive to a navigation within the scrollable iterator control, data associated with other content that is situated within the folder, wherein the data is retrieved from a remote resource; and
outputting at least some of the data as one or more icons within the scrollable iterator control.

9. A method comprising:
retrieving, from a folder maintained by a web resource, an instance of content situated in the folder and information about one or more subfolders situated in the folder; and
outputting the instance of content and a folder iterator control adjacent to the instance of content, the folder iterator control being scrollable to present a plurality of icons associated with other instances of content situated in the folder and the one or more subfolders, at least one of the plurality of icons being selectable to navigate to a subfolder page associated with one of the one or more subfolders.

10. A method as described in claim 9, further comprising retrieving the instance of content and the information about the one or more subfolders responsive to a selection of a hyperlink.

11. A method as described in claim 9, wherein the folder iterator control is configured to dynamically retrieve one or more icons responsive to a navigation within the folder iterator control.

12. A method as described in claim 9, wherein at least one of the plurality of icons is selectable to retrieve and display another instance of content from the folder.

13. A method as described in claim 9, further comprising outputting a subfolder page responsive to a selection of one of the plurality of icons.

14. A method as described in claim 13, wherein the subfolder page comprises a subfolder iterator control that is scrollable to display icons associated with content situated within the one or more subfolders.

15. One or more computer-readable media comprising instructions that are executable by a device to:
receive a selection of a subfolder icon within a first iterator control, the first iterator control being configured to present one or more representations of content and one or more representations of subfolders that are situated within a folder; and
navigate to a subfolder associated with the subfolder icon, the subfolder including a second iterator control that is configured to present one or more representations of content that is situated within the subfolder.

16. One or more computer-readable media as described in claim 15, wherein the folder and the subfolder are hosted by a web-based resource.

17. One or more computer-readable media as described in claim 15, wherein one or more of the representations of content are selectable to retrieve content from a web-based resource.

18. One or more computer-readable media as described in claim 15, wherein one or more of the representations of content comprise a thumbnail image of content.

19. One or more computer-readable media as described in claim 15, wherein one or more of the first iterator control or the second iterator control are configured to dynamically retrieve one or more icons from a remote resource and responsive to a navigation within the first iterator control or the second iterator control.

20. One or more computer-readable media as described in claim 15, wherein the folder is accessible via a uniform resource locator (URL).
